(19) United States
(12) Patent Application Publication
(10) Pub. No.: US 2009/0323799 A1
(43) Pub. Date: Dec. 31, 2009

(54) SYSTEM AND METHOD FOR RENDERING A HIGH-PERFORMANCE VIRTUAL DESKTOP USING COMPRESSION TECHNOLOGY

(75) Inventor: Darryn D. McDade, SR., Livermore, CA (US)

Correspondence Address: STMICROELECTRONICS, INC., MAIL STATION 2346, 1310 ELECTRONICS DRIVE, CARROLLTON, TX, 75006, US

(73) Assignee: STMICROELECTRONICS, INC., Carrollton, TX (US)

(21) Appl. No.: 12/146,276

(22) Filed: Jun. 25, 2008

(51) Int. Cl. H04B 1/66; H04N 7/173

(52) U.S. Cl. 375/240.01; 725/114; 375/E01.001

(57) ABSTRACT

An embodiment of a network of extendable computer resources creates a virtual computing environment for a remote client. The network allocates at least some of the extendable computer resources to the virtual computing environment and compressively represents video output information of the virtual computing environment as an encoded data stream. The encoded data stream is communicated to the remote client, and input information to control the resources allocated to the virtual computing environment is received from the remote client. An embodiment of a local computing client receives a multiframe motion picture stream of encoded signals that represent the video output of a virtual computing environment hosted by a remote computer source. The local computing client decodes the motion picture stream, accepts input information operable to control the virtual computing environment, and communicates the input information to the remote computer source.

### BACKGROUND

1. Technical Field

A high-performance desktop that includes a thin client, heavy computing server model, and more particularly, a system and method for providing high-performance computing resources running on remote servers to local users operating low-cost terminals are disclosed.

2. Description of the Related Art

In the early days of modern digital computing, physically large computing devices were controllable through a single, directly connected interface. As the digital electronics industry evolved, it became possible to remotely locate a central mainframe computer and to locally operate one or more ‘dumb’ terminals. The dumb terminals could each access and control the computing resources of the large, central mainframe from a separate location. This original dumb terminal/mainframe model was a predecessor to current client-server models.

Continued evolution in the digital computing industry led to the creation of mini-computers. Mini-computers are smaller than mainframe computers, but still have powerful computing resources. A terminal with more processing ability than a dumb terminal is most often used to control a minicomputer, but the terminal is generally not useful without connectivity to the mini-computer.

Still further evolution led to the development of small, autonomous personal computers, such as desktop, laptop, and palm-top computers. Even today, manufacturers continue to fit full computer architectures into smaller and smaller spaces. As such, the strategic advantage of some computer manufacturers is to innovatively produce smaller and smaller computers in sufficiently high volume so as to earn financial profits.

The advances in modern computing referenced above are impressive, and modern personal computers can provide some level of powerful computing resources to an individual user, but a personal computer is not necessarily efficient. For example, limitations on the calculating speed of a central processing unit (CPU) and limitations on other parts of the personal computer such as memory (volatile and non-volatile), media read/write drives, scanners, printers, etc., can impact how efficiently a user can operate a personal computer. Thus, even though advances in technology can be rapidly integrated, and even though the cost to a manufacturer of producing computers can be efficiently scaled, the cost to an individual user of keeping up with the advancing technology can be prohibitive. Indeed, even the cost of purchasing a single personal computer can be prohibitive.

One solution to some of the limitations of autonomous personal computers was a partial return to the prior client-server model. Ongoing advances in hardware and software technologies led to an approach wherein powerful computing resources are networked together in a remote location in a manner that permits shared allocation of the computing resources to individual users. Access to these remote networks, through a server of the powerful computing resources, is provided to individual users, each still operating a personal computer.

In the prior client-server model, where a server provided access to a network of available computer resources, multiple users were granted access to individual ‘virtual’ software environments running on the remote network of computing resources. When a user ran a corresponding local client software program on his personal computer, he was able to access and control his allocated virtual software environment, which was running on the remote network. In some cases, if the user desired additional computing resources, such as more or faster central processing unit cycles for example, then the requested resources could be allocated by the remote network from an available pool of computing resources. However, the user was still using a personal computer with a large memory and one or more CPUs and graphic boards.

For computer manufacturers and computer-using consumers, the effectiveness of continuing to follow the prior client-server model is limited. From the manufacturer's perspective, the advances in technology that are integrated into new hardware are limited by how effectively access to the advanced technology can be delivered to an end user. For example, advanced server models can produce high-performance graphics, but such graphics are not readily deliverable to client users. From the consumer's perspective, using a full architecture personal computer to access the advanced technology hosted by a remote server is not cost-effective because many of the expensive personal computer resources are left idle much of the time, even sometimes, while the user attempts to access more advanced resources on the remote network. Accordingly, improvements in the delivery and receiving mechanisms of remote computer resources and local computer users would benefit both manufacturers and consumers.

### BRIEF SUMMARY

A method for rendering a high-performance virtual desktop using compression technology is taught. Further, client and server systems that generate, communicate, and control high-performance computing resources are also taught.

In some cases, from the perspective of a server system, the server is described as a local component and one or more hosted client systems are described as remote components. Similarly, from the perspective of a client system, the client is described as a local component and a server system is described as a remote component. Thus, the classification of “remote” and “local” components is most reasonably understood from the detailed discussion of the particular component.

According to one embodiment, the method includes locally receiving a multiframe motion picture stream or other video stream of encoded signals generated by a remote computer source. The stream provides a video output of a virtual computing environment hosted by the remote computer source. The local client decodes the multiframe motion picture stream with a local decoding system. The local client system accepts input information from the user that is operable to control the virtual computing environment, and communicates the input information to the remote computer source.

According to another embodiment, a method for providing computing resources includes creating a virtual computing environment for a client within a network of extendable computer resources, allocating at least some of the extendable computer resources to the virtual computing environment, compressively representing video output information of the virtual computing environment as an encoded data stream, communicating the encoded data stream to the client, and receiving input from the client to control the resources allocated to the virtual computing environment.

A client apparatus includes a receiving circuit and a decoder coupled to the receiving circuit. The decoder is configured to decode a data stream encoded with an algorithm, the data stream using a display output from a virtual machine running on a remote computer. The client machine includes a processing circuit adapted to arrange the decoded stream into a video display format and a presentation circuit adapted to communicate the arranged decoded stream to an output display device. An input device configured to receive client input information, an encoder and a transmitting circuit coupled to the input circuit, the transmitting circuit configured to communicate the user input information to the remote computer may also be part of the client.

A computing server apparatus includes an extendable network of computing resources and an encoder configured to compressively encode a video stream using an algorithm. The video stream is separately derived from a virtual graphical user interface (GUI) of a virtual machine running within the extendable network of computing resources. The computing server includes a transmitting circuit coupled to the encoder, the transmitting circuit operable to communicate an encoded video stream to the client, and a receiving circuit operable to receive information and control signals from the remote client.

### BRIEF DESCRIPTION OF THE SEVERAL VIEWS OF THE DRAWINGS

The components in the drawings are not necessarily to scale relative to each other. Like reference numerals designate corresponding parts throughout the several views.

FIG. 1 is a block diagram illustrating traditional, prior art personal computer architecture.

FIG. 2 is an illustration of conventional prior art client-server architecture.

FIG. 3 is an overview block diagram illustrating an exemplary new system capable of rendering and controlling a high-performance virtual desktop using compression technology.

FIG. 4 illustrates an embodiment of a new server farm having hardware and software useful to communicate a high-performance virtual desktop using compression technology.

FIG. 5 illustrates an embodiment of a new client model having hardware and software useful to render and control a high-performance virtual desktop using compression technology.

FIG. 6 is a flowchart illustrating a process used by an exemplary embodiment of a server capable of communicating a high-performance virtual desktop using compression technology.

FIG. 7 is a flowchart illustrating a process used by an exemplary embodiment of a client capable of rendering and controlling a high-performance virtual desktop using compression technology.

### DETAILED DESCRIPTION

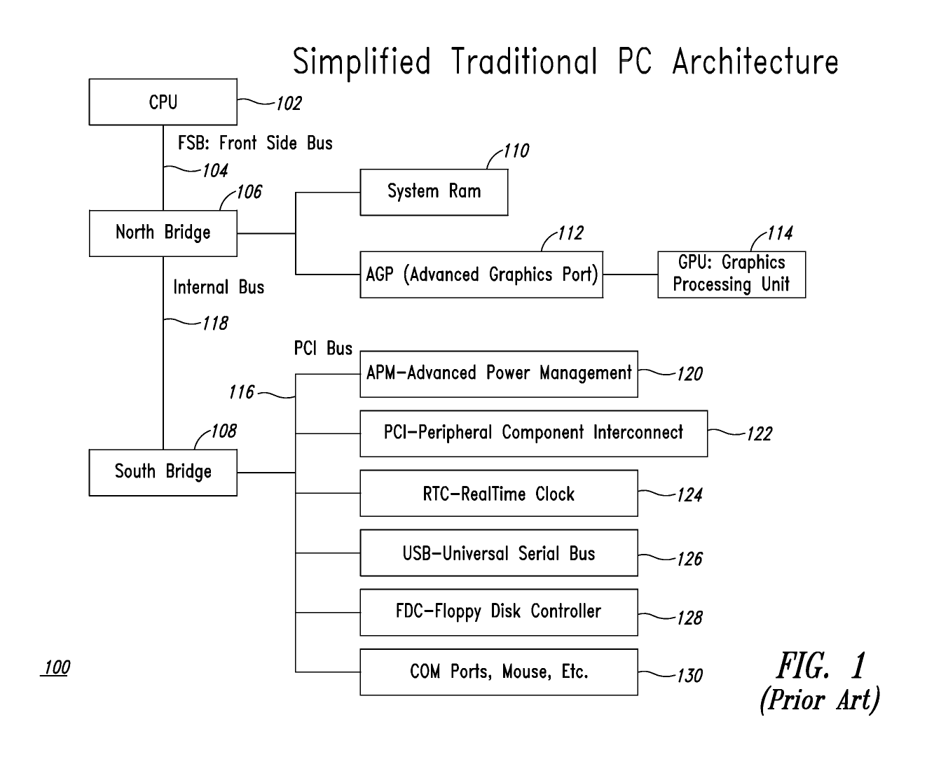

FIG. 1 is a block diagram illustrating traditional, prior art personal computer architecture. An exemplary embodiment of a computer 100 has one or more central processing units (CPU) 102 for performing mathematical and logical operations within the computer 100. The CPU 102 accesses components internal and external to the computer 100 primarily through a front side bus (FSB) 104, to which are coupled a north bridge 106 module and a south bridge 108 module.

The FSB 104 is a multi-bit, bi-directional data bus that allows the components in the computer 100 to send and receive data from the CPU 102 as necessary. The north bridge 106 and south bridge 108 modules are special purpose processors that collect and distribute data between the CPU 102 and specific components in the computer 100. Generally, the north bridge 106 is tasked with memory related duties, and the south bridge 108 is tasked with input/output (I/O) related duties. The data collected and distributed by the north and south bridges 106, 108 is generally passed across the FSB 104.

In the embodiment of FIG. 1, system RAM 110 and an advanced graphics port (AGP) 112 communicate information to and from the CPU 102 through the north bridge 106. A high-performance graphics processing unit (GPU) 114 is shown in the computer 100 as attached through the AGP 112; however, many variations to this basic model are permitted. For example, in modern high-performance systems, such as illustrated in the embodiment of FIG. 1, the GPU 114 is a memory intensive processing unit attached to the AGP 112. In other systems, the GPU 114 may be attached to a PCI bus 116 or some other bus. In any embodiment of a traditional computer system, however, the GPU 114 is associated with the CPU 102 and communicates with the CPU 102 over one or more buses.

The south bridge 108 is shown in a preferred embodiment of FIG. 1 as coupled to the north bridge 106 through an internal bus 118. In the embodiment of FIG. 1, the south bridge 108 provides the CPU 102 with access to various I/O peripherals over a PCI bus 116. The illustrated peripherals include advanced power management (APM) 120, peripheral component interconnect (PCI) 122, real time clock (RTC) 124, universal serial bus (USB) 126, floppy disk controller (FDC) 128, and communication (COM) ports, mouse, etc., 130 modules. The modules shown are representative of the types of modules that may be coupled to the CPU 102 through the south bridge 108; however, other modules and/or different modules may be coupled to the CPU 102 in a different manner. The personal computer therefore includes a complex bus system, one or more CPUs, and usually a GPU.

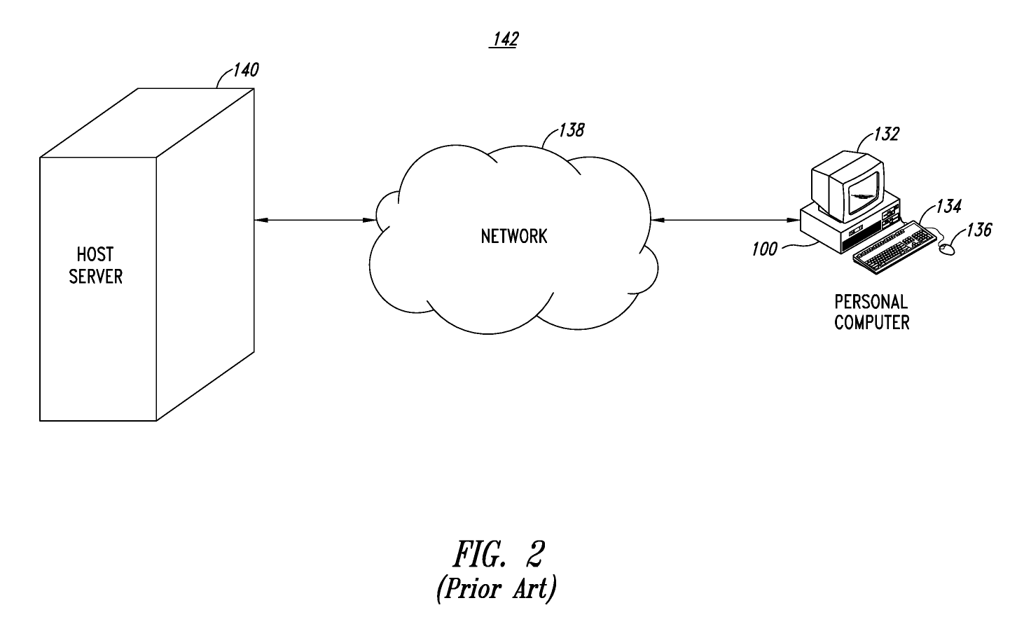

FIG. 2 is an illustration of conventional client-server architecture 142. A representative computer 100, such as a computer illustrated in FIG. 1, also has an attached display 132, keyboard 134, and mouse 136. The computer 100 is bi-directionally attached through a network 138 to a host server 140.

The network 138 of FIG. 2 may be any wired or wireless network and/or may include both wired and wireless components. For example, in some embodiments, the conventional client-server architecture is employed in an environment where a telephone, email, print, Internet, or other host server 140 provides computer services to a computer 100 over a wired network. In another environment, the host server 140 may provide computer services over a wireless network. In still other cases, however, the host server 140 and any coupled computers 100 may be located at substantial distances from each other, and the network 138 may have many wired and or wireless components.

The conventional client-server architecture 142 illustrated in FIG. 2 is, in some cases, very inefficient. For example, as described above, a conventional computer 100 can be very expensive. In some cases, the expense of the computer 100 is disproportionate to the amount of computing power that a user needs or wants. For example, some users merely want to send email or access other information on the world-wide-web through the Internet. Thus, to some users, it is inefficient to purchase a high-cost, high-performance computer 100 having characteristics such as a very fast CPU 102 and a high-performance GPU 114.

As another example, other users may have use for a very high-performance computer that is at or even well beyond the capabilities of a standard personal computer 100. This type of user may be performing operations that require an extremely large number of calculations or memory operations. Thus, to some users, perpetually purchasing newer and faster high-performance computers 100 to keep up with technology advances is inefficient.

Another example is a user that requires aspects of both low-cost and high-power computing. For example, a person on a limited budget may want to participate in graphics-intensive, networked computer gaming, but such a person may also have insufficient funds to purchase a computer system with the adequate resources. Thus, to some users, obtaining a low-cost local computer having access to a high-performance computing system is inefficient and/or even impossible.

As an alternative to both the traditional PC architecture and the conventional client-server architecture of FIGS. 1 and 2, a new client-server model 144 is proposed. In some embodiments of this new model, the hardware, software, and network interconnectivity are all new, and in other cases, the new model 144 employs aspects of traditional hardware, software, and network interconnectivity combined with new features.

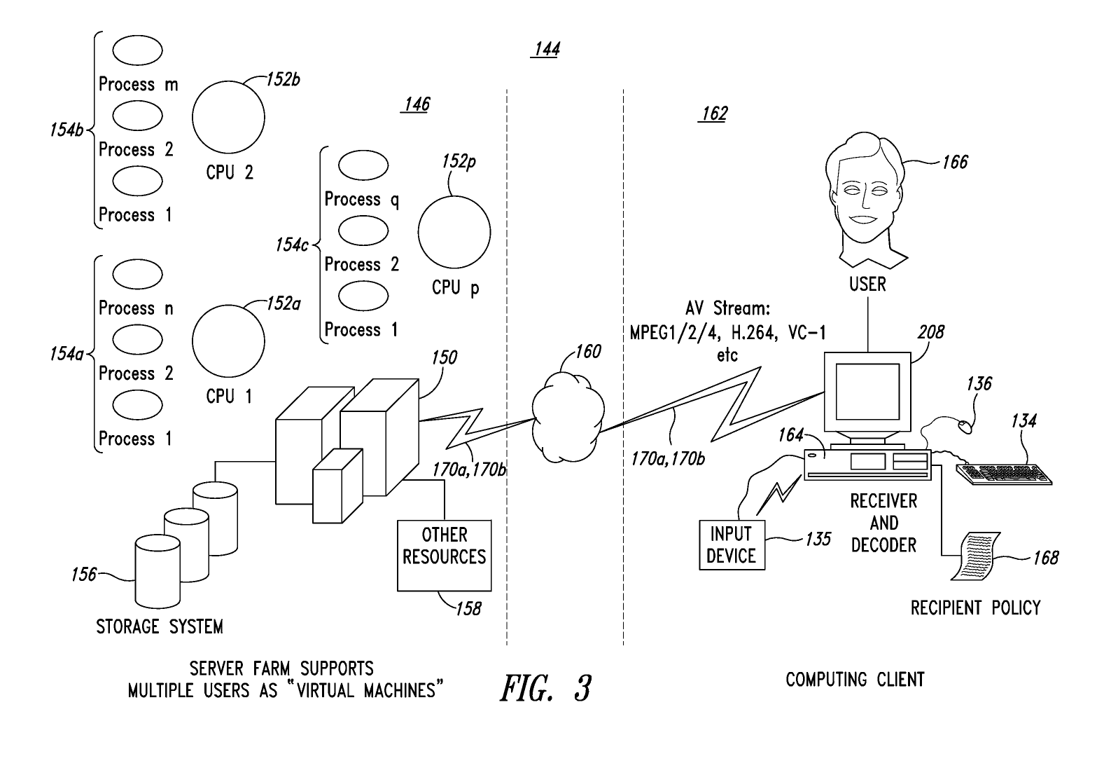

FIG. 3 is an overview block diagram illustrating an exemplary new system 144 capable of rendering and controlling a high-performance virtual desktop using compression technology 144. FIG. 3 shows the exemplary compression system 144 having a server farm 146, a network 160, and a computing client 162.

The server farm 146 has one or more servers 150 running commercially available virtual machine (VM) simulation software on multiple CPU's 152a-152p. The server farm 146 can drive one or more computing clients 162 and supply as many or as few computing resources as required by the computing clients 162. The embodiment of FIG. 3 employs the new client-server model 144 described herein.

In the client-server model 144 of FIG. 3, a server farm 146 has one or more host servers 150. The host servers 150 have one or more CPUs 152a-152p. The CPUs 152a-152p are capable of running one or more independent and/or dependent processes 154a, 154b, 154c. In addition to central processing units, the host servers 150 also have a storage system 156 and a multitude of other resources 158 that are accessible by the CPUs 152a-152p. One general characteristic of the server farm 146 is that additional computing resources may be dynamically added as desired or required. For example, additional CPUs, storage space, software applications, and/or peripherals can be added or removed from the server farm 146.

A network 160 couples the server farm 146 to a computing client system 162. Network 160 may be any wired, wireless, or combination of network media useful to interconnect one or more new local computing clients 162 with a remote server farm 146. For example, network 160 may include many different types of communication hardware and software now known or later developed. Non-limiting communication media examples include telephony systems, the Internet, cable networks, fiber optic networks, microwave networks, asynchronous transfer mode (ATM) systems, frame relay networks, digital subscriber loop (DSL) systems, radio frequency (RF) networks, and satellite systems. More than one computing client 162 may be granted access to the server farm 146 through network 160; however, a single client 162 is shown for simplicity.

The computing client 162 of FIG. 3 is illustrated as including a video receiver 164, having a decoder, an associated mouse 136 and keyboard 134; however, the computing client 162 is not so limited. Mice and keyboards are common input peripherals for many computing platforms, and the video receiver 164 of FIG. 3 may include a mouse 136, keyboard 134, or other user input device 135. The input peripherals are often wired devices, but in some cases wireless devices are used as well to provide additional user convenience.

A user 166 is able to interactively control the computing resources allocated by the server farm 146 to the computing client 162. A particular recipient policy 168 is used to identify the computing client 162 to the server farm 146 and direct the computing resources that are available to the user 166.

One aspect of the new client-server model 144 is that output data from the computing resources of the server farm 146 is delivered to the computing client 162 as a compressed and encoded audio-video (AV) stream 170a. That is, the computing resources, including CPUs 152a-152p working cooperatively with the storage system 156 and other resources 158, produce real or emulated AV output. The server farm 146 may then utilize modern movie compression technology to generate a high-performance audio and video stream suitable for transmission across network 160. The compression technology may be MPEG, satellite signals, multiplex, time shared packets or other high rate of delivery of video and audio streams. Upon receipt by the computing client 162, the AV data stream 170a is decoded into a format suitable for audio and video output devices associated with a video receiver 164 or other compatible receiving device.

The remote computer server farm 146 generates a computer based output in the form of an encoded video stream output that is comparable to a movie being transmitted over the network 160, which signal is received by the client 162 and decoded to appear on the client's display 208 as if it were a standard computer output. Therefore, the client need only have a decoder of the type normally used in a set-top box for decoding movies or video and audio signals received over a network. An expensive bus system, multiple CPUs, a GPU, large memory and other aspects of a personal computer are not needed; rather, a decoder to decode the transmitted signal and an encoder to encode and transmit back a control signal is needed.

The exemplary system of FIG. 3 also shows how the server farm 146 can grant access to as many or as few computing resources required by the computing client 162. Within the server farm 146, host server 150 runs virtual machine (VM) simulation software on multiple CPU's 152a-152p. The server farm 146 can allocate or de-allocate resources within a VM. Allocation and de-allocation may occur according to a recipient policy 168, by requests from the computing client 162, or via some other means. For example, allocation and de-allocation may occur according to the volume of demands of many computing clients 162, the availability of resources to the server farm 146, or by some other policy.

Accordingly, this new client-server model 144 solves the lack of efficiency produced by the conventional client-server model of FIG. 2. That is, the client-server model 144 enables operators of server farms 146 to efficiently produce and deliver robust computing power and very high graphics quality to users 166 at competitive prices. The client-server model 144 also permits a very low-cost consumer client 162 to achieve extremely high graphics quality and/or significant computing power by leveraging the compressed and encoded output of servers 150. Simply put, in the new client server model 144, unlimited computing power, unlimited memory, unlimited storage, and high quality graphics are at the computing clients' 162 disposal with merely a decoder and an encoder at the local client device 162.

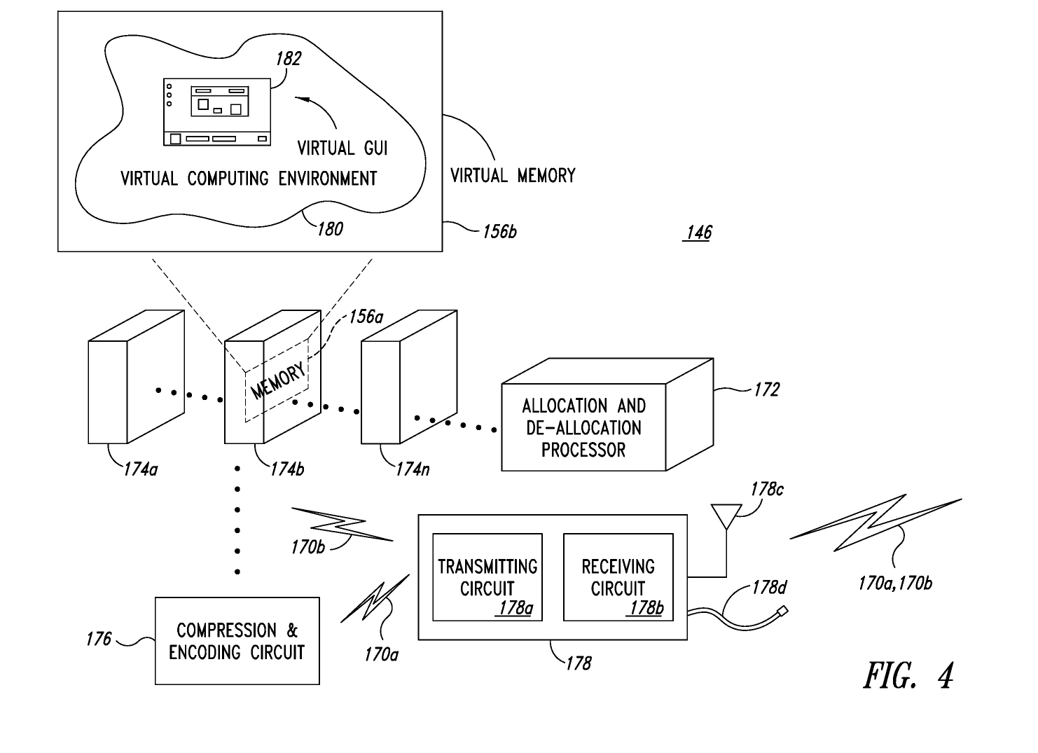

FIG. 4 illustrates an embodiment of a server farm 146 having hardware and software useful to communicate a high-performance virtual desktop 186 using compression technology. A computing server, for example the server model 150, employs at least one host server 150, however, the exemplary embodiment of FIG. 4 is shown as having several host servers 174a-174n. The host servers 174a-174n employ one or more CPUs 152a-152p, which execute mathematical, logical, and other computer operations as directed by software written and/or controlled by users 166.

The server farm 146 additionally may have an allocation/de-allocation processor 172. The allocation/de-allocation processor 172 may be a single processor, multiple processors, or a combination of processors. Alternatively or additionally, the operations and functions of an allocation/de-allocation processor 172 may be contained in and provided by CPUs 152a-152p within one or more host servers 174a-174n. As described in more detail below, in some cases, the allocation/de-allocation processor 172 is controlled by operations dedicated to the server farm 146, and in other cases, the allocation/de-allocation processor 172 is controlled according to information received from a remote client 162.

The allocation/de-allocation processor 172 functions to add and remove physical resources to/from the server farm 146. Thus, an embodiment of a host server 174a-174n appears to a remote computing client 162 as a network of extendable and unlimited computer resources. The allocation/de-allocation processor 172 further functions to allocate and de-allocate specific computing resources of the server farm 146 to computing clients 162 using the server farm 146. Accordingly, users 166 requiring such resources as high-end graphics, high-performance video and vast computing power are served equally well as users 166 requiring only minimal computing resources.

As previously indicated, host servers 174a-174n have access to memory storage space 156. The memory storage space 156 is any single internal or external volatile or non-volatile memory or any combination thereof. For example, host server 174b of FIG. 4 is illustrated as having internal memory 156a. At least some portion of the physical memory 156a may be further identified as virtual memory 156b. Many modern computer systems allocate physical memory address space to software programs as conceptual virtual memory address space. This is often done for reasons of sharing, security, and extensibility. Although the practice of virtual memory implemented through virtual addressing is not necessary in this embodiment, a virtual memory space 156b as in FIG. 4 is one option shown for ease in describing the server farm 146. That is, the virtual memory 156b may be implemented as addressable virtual memory and/or the virtual memory 156b may be a physical memory space allocated to a specific computing client 162.

A virtual computing environment (VCE) 180 is illustrated within virtual memory 156b. A VCE 180 is an initial virtual address memory space of a particular size specifically created by operations within a host server 174a-174n and allocated to a remote computing client 162. The computing client 162, which has been granted access to the host server system 174a-174n of server farm 146, is then permitted to instantiate one or more operating systems, program applications, or other software components within the VCE 180. To the computing client 162, the VCE 180 is an environment and gateway to powerful computing resources that are available within the server farm 146. In some cases, the VCE 180 appears to the computing client 162 as a virtual machine responsive to control information provided by the user 166.

In some cases, a virtual computing environment 180 is shared amongst many computing clients 162, and in other cases, the virtual computing environment 180 is private to one computing client 162. It is understood that the virtual computing environment 180 of FIG. 4 and described herein is not limited to either shared or private computing environments. In fact, a virtual computing environment 180 may be exclusive to a single computing client 162 and inaccessible by any other remote computing client 162, shared between (and accessible by) several computing clients 162, or completely accessible to all potential computing clients 162.

Within a VCE 180, a user 166 may operate a virtual or actual complete instantiation of a computer operating system. For example, to the user, the VCE 180 may run a complete MICROSOFT VISTA, MACINTOSH LEOPARD, UNIX, or other operating system and the user 166 may even operation several operating systems. Further, within an operating system running in the VCE 180, the user 166 may be able to execute and control any reasonable number of applications, programs, or other computing operations. Thus, the number of applications, programs, and other computing operations may be limited by a host policy, a client policy 168, the amount of resources available, or other like means.

In some cases, the computing operations performed by a user 166 are simple email exchanges or other Internet accesses. In other cases, the computing operations are fast, video and graphics-intense gaming-type applications. In still other cases, the computing operations are complex scientific modeling, which requires vast CPU calculating power. In fact, the computing operations may be as simple or as complex as a user 166 may require, and since the server farm 146 permits dynamic accumulations of additional computing resources via the allocation/de-allocation processor 172, a vast array of computing services is available to the user 166 operating the computing client 162.

Within the VCE 180 of FIG. 4, an embodiment of a virtual GUI 182 instantiated by a host server 174a-174n is illustrated. The embodiment of virtual GUI 182 and other video output information of the VCE 180 may be as simple or as complex as permitted or requested by the user. Most often, the GUI 182 is used as an interface through which a user 166 has access to the hardware and software resources of a server farm 146.

In one example, a GUI, such as virtual GUI 182, is a representation of a typical display output of a MICROSOFT WINDOWS operating system. In other examples, a GUI, such as virtual GUI 182, is a representation of merely an email client program or an Internet browser program. More particularly, the representation of a GUI, such as virtual GUI 182, is defined by characteristics of the VCE 180 directed by a user 166 and allowable by the actual or emulated capabilities of the server farm 146 hardware.

In fact, the host server 174a-174n may or may not have any actual graphics output hardware. The server farm 146 may merely emulate graphics hardware as if a GPU was actually present. In such cases, regardless of whether any GPU hardware is actually available to the host server 174a-174n, the server will compress and encode a representative computer output, for example a GUI, as might be produced if a GPU were actually present.

The circuits used to compressively encode the computer output, for example a video stream, may be circuits or other components such as compression and encoding circuit 176. Accordingly, by combining the virtual machine capabilities of a VCE 180 and the output from a compression and encoding circuit 176, the server farm 146 permits a computing client 162 to emulate the work of a traditional PC client, including the operating system, functions, applications, etc.

The compression and encoding circuit 176 operates to receive and capture video, graphics, and audio output information that is emulated, produced, and otherwise derived from the server 174a-174n. The output information is received in several forms such as static data, fully constituted frames, partial frames, streaming data, and raw multimedia bus data. The compression and encoding circuit 176 further operates to apply appropriate compression and encoding algorithms to the received output data to produce a data stream for communication to a remote computing client 162.

For example, in one embodiment, a user 166 requests that a media application running in an assigned VCE 180 operate on a particular file. The application, which is running within the bounds of the server farm 146, produces audio/video output information. The output information, which is presentable on a GUI 182 of a virtual machine, is captured by compression and encoding circuit 176. After compressing and encoding the output information as a motion picture video stream 170a, the stream 170a is communicated over the network 160 to the remote computing client 162, where it is presented to the user 166.

The compression and encoding circuit 176 may be internal or external to the server farm 146 or combinations thereof. Further, the compression and encoding circuit 176 may include hardware, software, or both hardware and software modules.

The compression and encoding circuit 176 may use any type of compression algorithms or encoding circuits now known or developed in the future. For example, several methods of compression suitable for use within the server farm 146 include discrete cosine transform (DCT), fractal compression, matching pursuits, and discrete wavelet transform. One or more of these compression methods have been commonly embodied in algorithms such as H.261, H.262, H.263, H.264, MPEG-1, MPEG-2, MPEG-4, REALVIDEO, VC-1, VP6, and WMV. The algorithms and methods named are merely representative of compression and encoding algorithms presently available, of course any streaming algorithm may be suitable. This improvement over the conventional client-server model 142 of FIG. 2 permits a server farm 146 to provide either simple or high-performance video and graphics capability to a user 166 at low cost. Rather than requiring a high-end GPU to actually deliver AV output to the user 166, the compression and encoding circuit 176 communicates emulated high-performance video and graphics to the user 166 in the form of a multiframe motion picture stream of encoded signals 170a.

The compressed and encoded data stream 170a produced by compression and encoding circuit 176, which compressively represents the video and audio information of a VCE 180, is then passed to a communications circuit 178. Passing the data stream 170a may, or may not, include a physical transfer of the data, but instead may include loading pointers, flags, or the like to indicate to communications circuit 178 that the data stream 170a is ready for communication.

The communications circuit 178 includes transmitting and receiving circuits 178a, 178b. The communications circuit 178 hardware may be internal or external to the server farm 146 or some combination thereof. The communications circuit 178 may also include wired and wireless transmission and receiving hardware such as antennas 178c and cabling 178d. The communications circuit 178 operates to transmit outbound data streams 170a and to receive inbound control requests 170b.

The compressed representation of output 170a from host servers 174a-174n is generally targeted to a thin client such as computing client 162, but may also be received by other devices such as traditional PC architecture 100 (FIG. 1). As further described below, since the output from the server farm 146 is communicated as a compressively encoded data stream 170a, neither the server farm 146 nor the thin client 162 need contain an actual high-performance GPU. Instead, the thin client 162 need only be able to “decode” the compressed and encoded data stream for output to a local display accessible by the user 166.

In exemplary embodiments of server farm 146, a created VCE 180 is communicated to a remote computing client 162, and the remote computing client 162 is permitted to communicate control information back to the server farm 146. The control information, in some circumstances, is operatively configured to control the system wide functions of the VCE 180 and the virtual machine. In additional or alternative circumstances, however, the control information is also operative to control operations within the VCE 180.

Control of the VCE 180 and control of operations within the VCE 180 according to input 170b from the remote computing client 162 can take many forms. For example, the input information 170b from a remote computing client 162 may be configured to selectively control the allocation of computer resources or the release of previously allocated computer resources. The input information 170b may additionally or alternatively control specific operations of computer resources of the VCE 180 such as how and when software programs are executed within the VCE 180. That is, the control information 170b input to a remote client 162 is communicated back to the server farm 146 where the input 170b is processed by hardware and software within host servers 174a-174n. Then, the operations of the VCE 180 and other associated computer resources are, in some cases, controlled according to the input 170b received from the remote computing client 162.

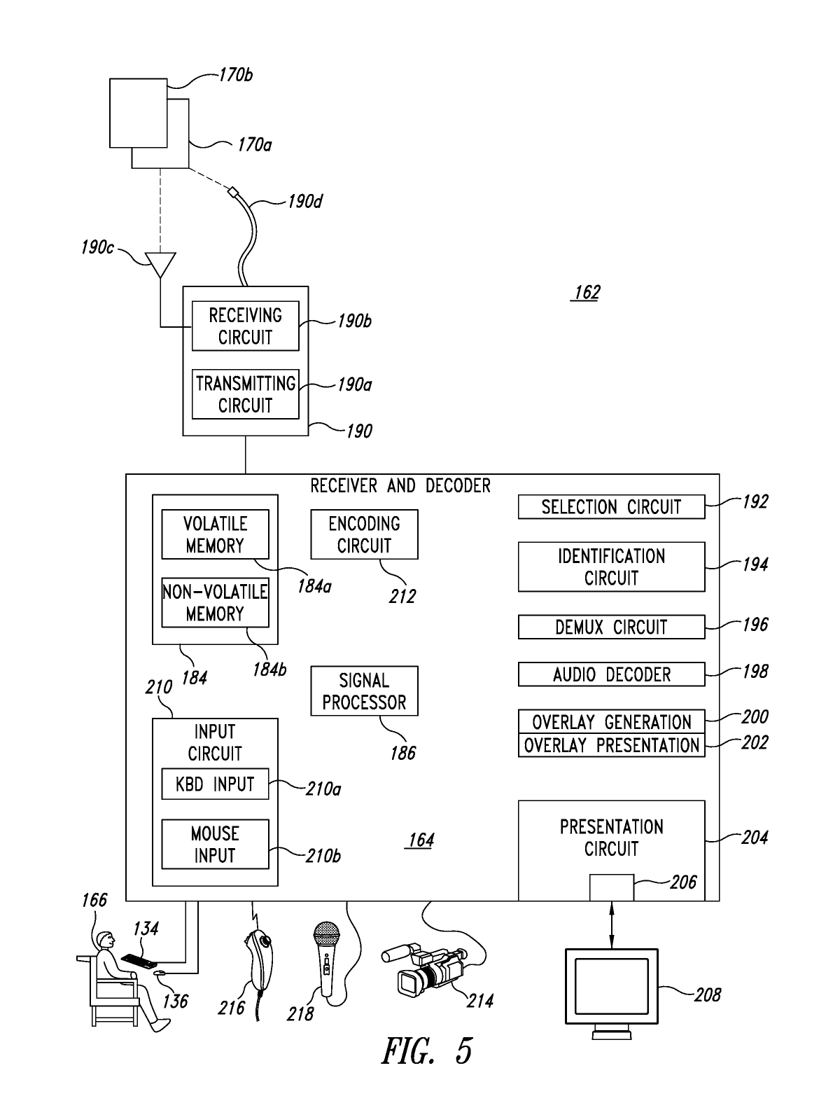

FIG. 5 illustrates an embodiment of a new computing client 162 having hardware and software useful to render and control a high-performance virtual desktop using compression technology. The computing client 162 of FIG. 3 is shown in more detail in FIG. 5. Embodiments of the client model 162 are particularly well-suited to operate in a distributed computing environment where one or more remote computer sources, for example server farm 146 of FIGS. 3 and 4, provide computing resources to one or more clients each having the architecture of computing client 162 or the like.

The computing client 162 may have either new or several known components. For example, as illustrated in FIG. 5, the computing client 162 includes a communication circuit 190 having associated transmitting and receiving circuits 190a, 190b. Any or all of the communications circuit 190 hardware may be internal or external to the computing client 162 or some combination thereof. Additionally, the communications circuit 190 may also have wired or wireless transmission and receiving hardware such as antennas 190c and cabling 190d. The communications circuit 190 operates to communicate inbound data streams 170a and outbound control requests 170b.

Computing client 162 also includes a video receiver 164, embodied as a decoder having decompression circuitry, coupled to the receiving circuit 190. The decoder 164 has several associated circuits and modules. For example, the decoder 164 has a decoder-based storage system 184 which has sufficient volatile and non-volatile memory 184a, 184b, for the decoder function. It may have a signal processor 186 to operatively control the computing client 162. The signal processor 186 may be one or more digital signal type processors and/or applications type processors that work cooperatively with the storage system 184 and other resources useful to carry out the decoding and encoding functions of the computing client 162.

In an exemplary embodiment of the computing client 162, one or more other circuits, such as a selection circuit 192, an identification circuit 194, a de-multiplexing circuit 196, an audio decoder 198, an overlay generation circuit 200, an overlay presentation circuit 202, and a presentation circuit 204 are also included in the decoder 164. These additional circuits are useful to perform functions desirable in the computing client 162. These additional circuits may further include hardware, software, or combinations of both hardware and software modules. In some cases, the additional circuits are dedicated software algorithms executed by signal processor 186.

For example, when one or more compressively encoded data streams 170a are received by the communications circuit 190 of the computing client 162, the identification circuit 194 is operable to identify the encoding and compression method or algorithm useful to decode the data. Upon identification, the selection circuit 192 selects an appropriate method or algorithm useful to the signal processor 186 for decoding the data stream 170a. The data stream 170a is stored in the storage system 184 prior to and during processing by the computing client 162.

Once a proper algorithm or method of decoding the data stream 170a is identified, the signal processor 186 operates as a decoder and decodes the data stream 170a as a function of the algorithm or method selected. In an exemplary embodiment, the signal processor 186 accesses a specific set of program instructions stored in the memory storage system 184. The instructions, which are executable by signal processor 186, direct signal processor 186 to decode the received data stream 170a according to the selected algorithm.

In some cases, the encoded data stream 170a comprises one or more sets of constituent data frames, and the identification circuit 194 further assists the signal processor 186 in identifying and parsing the individual frames. For example, in one embodiment, the computing client 162 receives an MPEG data stream 170a from a server farm 146. As the data stream 170a is received from the remote source, the data is processed using signal processor 186 and other hardware circuits and software of the computing client 162. The MPEG data stream 170a was encoded within the remote server farm 146 as a group of pictures. The group of pictures is defined by sequences of constituent frames of several frame types. That is, within the MPEG architecture, several frame types are defined including “intra frames” (iFrames), “bi-directional frames” (bFrames), and “predictive frames” (pFrames) or the like. As the constituent frames of the multiframe motion picture stream are received and identified, the frames are processed according to the appropriate decoding algorithm selected by the selection circuit 192.

In some cases, the signal processor 186 is adapted to further format, arrange, and process the decoded data stream into a video signal compatible with a video display format. For example, video display formats such as NTSC, PAL, or other appropriate formats are useful to permit typical or particular output display devices to present the decoded information to a user 166. The formatting and processing may be performed by hardware, software, or a combination of hardware and software. In these embodiments, the display 208 may be a standard TV already available to the user rather than a specialized, high-resolution computer monitor.

The decoded data stream may then be communicated to a presentation circuit 204 and further communicated to an output port 206. The output port 206 is most often attached to an output device, for example, a display 208. In some embodiments, the output port 206 is a wired interface, and in other cases, the output port 206 is a wireless interface.

During decoding of a multimedia stream of information, the computing client 162 may also operate an associated de-multiplexer. For example de-multiplexing circuit 196 is useful to separate encoded video data from encoded audio data. The de-multiplexer 196 is implemented in hardware, software, or some combination of hardware and software.

Once the audio and video data streams are separated, or separately identifiable, the computing client 162 uses an audio decoder 198 circuit to decode the audio stream. That is, in some systems, where a virtual machine is running on a remote computer, such as a host server 174a-174n in server farm 146, the virtual machine can generate audio data as a stream 170a. The audio data 170a is communicated to the computing client 162 and locally presented to an audio output device.

The computing client 162 also has an optional overlay generation circuit 200, which is operable to create a mouse pointer, cursor, or other graphics associated with the output data stream 170a. A virtual pointer, for example, may be created for the benefit of a user 166 of the computing client 162 and overlaid on the decoded video image. The overlay of the pointer, cursor, and other graphics is generally performed as a separate output process, but in some cases, the overlay will be embedded in the video output stream of the arranged decoded data stream.

The output from the overlay generation circuit 200 is passed by an overlay presentation circuit 202 to the presentation circuit 204. In embodiments where pointers, cursors, and other graphics are not provided for by the remote host server 174a-174n, the overlay generation circuit 200 and overlay presentation circuit 202 can act individually or in cooperation to add the graphics locally.

When graphics such as cursors and pointers are included in the output stream, whether added locally or remotely, the graphics are viewed along with other data 170a from the remote computer on the local display output, for example display 208. A user 166 of the computing client 162 may thus view the output of a remote computer environment, for example a virtual GUI 182 (FIG. 4) of a virtual machine, on a display 208 attached to the computing client 162. In some cases, a cursor will indicate where, within a window allocated to the virtual machine for example, a user 166 can enter user input keystrokes. In other or additional cases, a pointer will be displayed and the user 166 can move the pointer by supplying planar coordinate information associated with the window.

Accordingly, in these circumstances, the computing client 162 will also have an input circuit 210 that includes circuitry for receiving input information. A common keyboard 134 and a common mouse 136 can be used as interfaces to accept input from a user 166 and communicate the input to the appropriate input circuits 210a, 210b. Other user input useful to control the remote computer environment 180 is also possible, and such user input may include but is not limited to automated programmatic control, infrared control input, motion detection control, and audio control input. That is, in some embodiments, input circuit 210 has hardware and software operable to accept user input keystrokes, user input pointer and selection commands, and input information from other electronic computer interfaces. The input information is useful to control local and/or remote computing resources, for example, the local functions of computing client 162 and the functions of a remote computer environment, such as a VCE 180 operating within a server farm 146.

The signal processor 186 or another processor is used to process the user input from input circuit 210. In the exemplary embodiment of FIG. 5, the user input includes pointer coordinates input by a mouse 136 and related to a virtual GUI 182 and user keystrokes from a keyboard 134 useful for controlling the resources of the remote computer environment.

The embodiment of FIG. 5 also includes a video camera system 214 for detecting motion, a microelectrical mechanical system (MEMS) or other motion detection input device 216, and a microphone for inputting audio commands. Systems that incorporate a video camera or motion device are generally capable of detecting relative spatial position and passing the information into a computing device. For example, some video camera systems have a signal processing capability that is able to discern relative motion of objects within the field of view of the camera. As another example, some popular video game systems include MEMS based or other accelerometer-type handheld motion detection controllers that provide positional input into a computing device. Thus, the computing client 162 can mix and match any number of wired and wireless devices useful for inputting user information, wherein the user information input represents control requests 170b of a user 166 directed toward the remote computer environment of the server farm 146.

The user input information is encoded by an encoding circuit 212 and may also undergo additional processing, for example by signal processor 186. In some cases, the input information represents all of the information 170b to be communicated by the computing client 162, and in other cases, specific other information may be added prior to communication. For example, information that uniquely identifies a particular computing client 162 or user 166 may also be added. In FIG. 5, the accumulation of control information directed toward the remote computer server environment 146 is generally represented as control request 170b. It is understood that control request 170b may represent one or more specific actions taken by a user 166 to effect operations on the remote computer system 146.

Communication circuit 190 is operative to communicate client input information, such as control request 170b, back to a remote computing environment. In some cases, specific hardware and software, such as transmitting circuit 190a or an encoder 212, for example, are useful to communicate the information 170b. Exemplary embodiments of communication circuit 190 have wired, wireless, or combinations of wired and wireless modules.

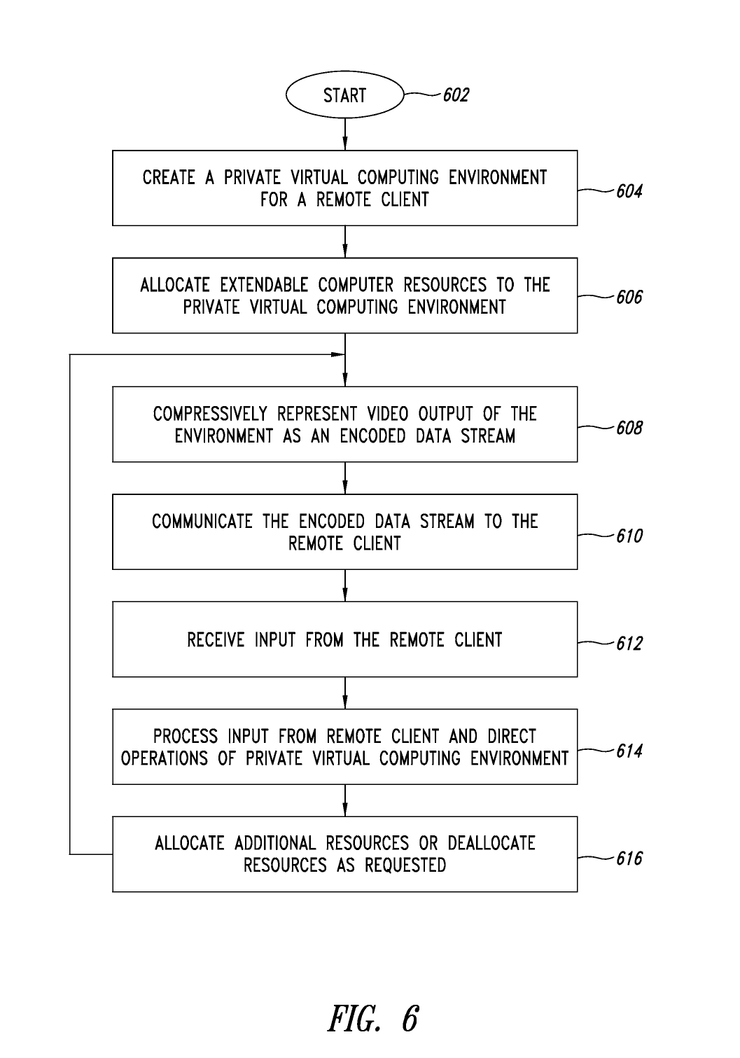

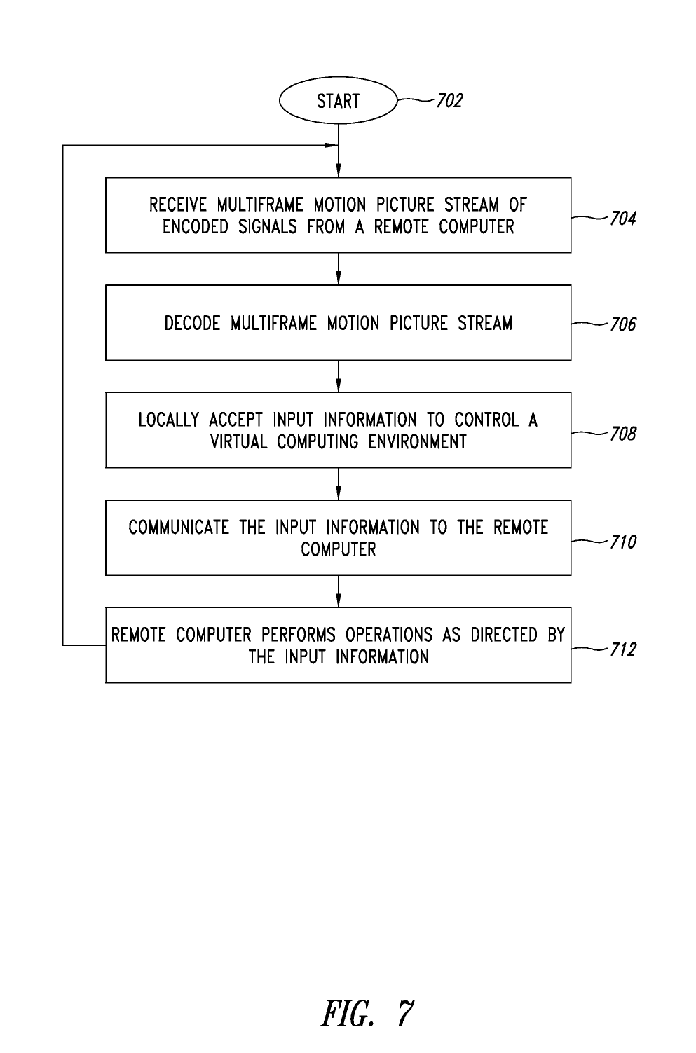

FIGS. 6 and 7 are flowcharts 600 and 700, respectively, illustrating processes used by exemplary embodiments of a server farm 146 (FIG. 4) and a computing client 162 (FIG. 5) capable of rendering and controlling a high-performance virtual desktop using compression technology. In this regard, each described process may represent a module, segment, or portion of code, which comprises one or more executable instructions for implementing the specified logical functions. Each described process may further be implemented in hardware, software, and/or some combination of both hardware and software. It should also be noted that in some implementations, the functions recited in the process may occur in a different order, may include additional functions, may occur concurrently, or may be omitted.

With respect to FIG. 6, the process 600 is ongoing with operation of the server farm 146 and is illustrated starting at 602. At 604, a host server 174a-174n creates a virtual computing environment (VCE) 180 for a remote client, for example, a computing client 162. At 606, the host server 174a-174n allocates extendable computer resources to the VCE 180. At 608, the host server 174a-174n compressively represents video output of the VCE 180 as an encoded data stream 170a, and at 610, the host server 174a-174n communicates the encoded data stream 170a to the remote client 162. At 612, the host server 174a-174n receives input 170b from the remote client. The input from the remote client 162 is processed and used to direct operations within the VCE 180 at 614, and additional resources are allocated or de-allocated as requested at 616. The process continues as directed by the computing client 162 or by operations in the server farm 146.

With respect to FIG. 7, the process 700 is ongoing with operation of a computing client 162 and is illustrated as starting at 702. At 704, the computing client 162 receives a multiframe motion picture stream 170a of encoded signals from a remote computer, for example, a server farm 146. At 706, the computing client 162 decodes the multiframe motion picture stream. At 708, the computing client 162 locally accepts input information to control a virtual computing environment executing within the remote computer, and at 710, the computing client 162 communicates the input information 170b to the remote computer. The remote computer accepts the input 170b and performs operations according to the input 170b at 712. The process continues with the remote computer sending additional multiframe motion picture streams.

As described in the exemplary embodiments above, the architecture of computing client 162 altogether eliminates the need to have graphics capability such as a high-performance GPU in the client. A traditional or high-performance GPU may be included, such as is included on most personal computers today, however the GPU is not necessary. Instead, a multiframe motion picture stream that represents a virtual GUI output may be decoded with particular hardware and software and locally displayed.

An exemplary system capable of rendering and controlling a high-performance virtual desktop is now discussed. The exemplary system 144 (FIG. 3), includes a non-limiting embodiment of a “cloud computing center” or “data center” such as a server farm 146 (FIGS. 3, 4), which practices compression technology. The exemplary system 144 also includes a client, such as computing client 162 (FIGS. 3, 5), which is operated by a user 166.

The exemplary system addresses the inefficiencies of prior computing configurations. A local client communicatively coupled to the new system supplies mouse coordinates, keyboard inputs, or other user control information to control a remote server system. The remote server system supplies the primary computational resources used by the local client and communicates the computational output to the local client.

The exemplary system is capable of emulating and even going beyond traditional PC architecture and conventional client-server systems. The servers are able to efficiently host a flexible arrangement of computational resources and deliver computational output as a compressively encoded audio-video stream to local client users. The local users are able to efficiently receive and decode the computational output and control the remote system addresses the inefficiencies of past systems.

The exemplary system employs a server, such as the server farm 146, having an extendable network of computing resources and an encoder configured to compressively encode a video stream using an algorithm. The encoded video stream is derived from an actual or virtual GUI of a virtual machine running within the extendable network of computing resources.

The exemplary system further employs a client, such as the computing client 162, having a decoder, processing means, and display means to present computational output to the user. The decoder is configured to decode the video stream encoded by the server farm 146. The processing means include a processing circuit adapted to arrange the decoded data stream into an appropriate video display format. The display means includes an attached display, which enable the user to view a representation of the GUI running on the remote server farm 146. Further, if the computing client 162 has input and communication circuits, then the user is also able to control the computing resources running on the server farm 146.

In some cases, the local client's processing and display means include a very high resolution and responsive terminal. In this circumstance, high quality audio and video output is efficiently produced by the remote server and delivered to the local client. The responsive terminal and processing means of the local client permit the efficient output of the audio and video to the user and communication of user input back to the remote server.

In other cases, the local client has a moderate or low resolution terminal. The primary computational resources still reside in the remote server, however, the user only requires basic email and world-wide-web type information, so the resources allocated in a remote server are minimal.

In still other cases, the local client user demands significant computational resources from the remote server. In this circumstance, more cost effective and high-performance compute engines can be shared, added and assigned by the remote server as needed. Thus, this type of local client has access to a nearly infinite supply of advanced computational resources.

Accordingly, a set top box may be preferably suitable to embody the computing client 162 of the exemplary system. For convenience, a set top box may be interchangeably known as a “television converter,” “receiver,”; “set top-box,” “television receiving device,” “television receiver,” “television recording device,” “satellite set top box,” “satellite receiver,” “cable set top box,” “cable receiver,” and/or “television tuner.” That is, a set top box may be any suitable converter device, decoding device, or electronic equipment that is operable to receive and decode audio and video signals having program content.

Modern set top boxes are configured to receive streaming video signals as a group of moving pictures. Individual frames are decoded, processed, and arranged in a format suitable for display on an attached device. Modern set top boxes are also configured to receive streaming audio signals. In many cases, streaming audio data is combined and synchronously associated with the video data.

It is not uncommon for producers of audio and video information to deliver the audio-video information to users via a set top box. Generally, the audio-video information is television, news, sports, and/or movie programming used to inform and/or entertain the user. In other cases, however, nearly any type of audio or video information may be communicated to a user through a set top box.

With very little modification, and in some cases with no modification, a set top box can also provide a user with access to a remote data center of extendable computer resources, for example a server farm 146. In some circumstances, the set top box can be configured to communicate basic information such as screen size, screen resolution, and the like back to the remote data center. In other or additional circumstances, the set top box is configured to receive control information from a user to prepare the control information for communication back to the remote data center. Accordingly, in some cases, a set top box may provide an efficient implementation of the computing client 162 in the exemplary system.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of distributed computing, comprising;
locally receiving a multiframe motion picture stream of encoded signals generated by a remote computer source, said stream representing video output of a virtual computing environment hosted by the remote computer source;
decoding said multiframe motion picture stream with a local computing client;
locally accepting input information operable to control the virtual computing environment; and
communicating the input information to the remote computer source.

2. The method of distributed computing of claim 1, further comprising:
formatting the decoded multiframe motion picture stream into a digitized video signal compatible with a video display format; and
presenting the formatted multiframe motion picture stream to an output port.

3. The method of distributed computing of claim 1 wherein the step of decoding said multiframe motion picture stream comprises:
storing data of the multiframe motion picture stream in a memory;
identifying constituent frames of the multiframe motion picture stream;
selecting an appropriate decoding algorithm from the group consisting of H.261, H.262, H.263, H.264₁ MPEG-1, MPEG-2, MPEG-4, REALVIDEO, VC-1, VP6, and WMV; and
processing the constituent frames according to the selected algorithm.

4. The method of distributed computing of claim 1 wherein the step of decoding said multiframe motion picture stream comprises;
storing data of the multiframe motion picture stream in a memory;
identifying constituent frames of the multiframe motion picture stream;
selecting an appropriate decoding algorithm, said algorithm decoding according to a method from the group comprising discrete cosine transform (DCT), fractal compression, matching pursuits, and discrete wavelet transform; and
processing the constituent frames according to the selected algorithm.

5. The method of distributed computing of claim 1 wherein the step of locally accepting input information comprises:
accepting user commands from a computer pointing device; and
accepting user commands from a computer keyboard.

6. A method of providing computing resources, comprising:
creating a virtual computing environment for a remote client within a network of extendable computer resources;
allocating at least some of the extendable computer resources to the virtual computing environment;
compressively representing video output information of the virtual computing environment as an encoded data stream;
communicating the encoded data stream to the remote client; and
receiving input from the remote client to control the resources allocated to the virtual computing environment.

7. The method of providing computing resources of claim 6, further comprising:
controlling the resources allocated to the virtual computing environment according to the input received from the remote client;
selectively allocating additional computer resources according to the input received from the remote client; and
selectively releasing allocated computer resources according to the input received from the remote client.

8. The method of providing computing resources of claim 6 wherein the step of creating the virtual computing environment for the remote client within the network of extendable computer resources comprises:
allocating a particular amount of virtual memory, said allocated virtual memory inaccessible by any other remote client;
instantiating, within the virtual memory, a graphical user interface that provides access to hardware and software resources within the network of extendable computer resources; and
presenting a representation of the graphical user interface window to components configured to encode the representation as a multiframe motion picture stream.

9. The method of providing computing resources of claim 6 wherein the step of compressively representing video output information of the virtual computing environment as the encoded data stream comprises:
capturing the video output information of the virtual computing environment, which is presentable as a graphical user interface; and
encoding said video output information according to an appropriate encoding algorithm.

10. A computing client apparatus, comprising:
a receiving circuit;
a decoder coupled to the receiving circuit, the decoder configured to decode a data stream encoded with an algorithm, said data stream representing a display output from a virtual machine running on a remote computer;
a processing circuit adapted to arrange the decoded data stream into a video display format;
a presentation circuit adapted to communicate the arranged decoded data stream to an output display device;
an input circuit configured to receive client input information; and
a transmitting circuit coupled to the input circuit, the transmitting circuit configured to communicate the client input information to the remote computer.

11. The computing client apparatus of claim 10 wherein the computing client apparatus is a set top box.

12. The computing client apparatus of claim 10, further comprising:
a demultiplexer to separate encoded video data from encoded audio data received with the receiving circuit; and
an audio decoder coupled to the receiving circuit, the audio decoder configured to decode an audio stream generated by the virtual machine running on the remote computer.

13. The computing client apparatus of claim 10, further comprising:
an overlay generation circuit configured to generate at least one virtual pointer; and
an overlay presentation circuit configured to present the generated at least one virtual pointer as an overlay onto the arranged decoded data stream representing the display output from the virtual machine.

14. The computing client apparatus of claim 10 wherein the input circuit comprises:
a circuit configured to accept input from a spatial motion detection device; and
an encoding circuit configured to encode the spatial motion input.

15. The computing client apparatus of claim 10 wherein the input circuit comprises:
a circuit configured to accept audio input from a transducer device; and
an encoding circuit configured to encode the audio input.

16. The computing client apparatus of claim 10, further comprising:
a keyboard input circuit configured to accept user input keystrokes;
a pointing device input circuit configured to accept planar coordinate information representing a location of a pointer within a window allocated to the virtual machine running on the remote computer; and
an encoding circuit configured to encode the user input keystrokes and planar coordinate information.

17. The computing client apparatus of claim 10 wherein the decoder coupled to the receiving circuit further comprises:
a memory;
a signal processor; and
a set of program instructions stored in the memory and executable by the signal processor to decode a received data stream according to an algorithm from the group consisting of H.261, H.262, H.263, H.264, MPEG-1, MPEG-2, MPEG-4, REALVIDEO, VC-1, VP6, and WMV.

18. The computing client apparatus of claim 10 wherein the decoder coupled to the receiving circuit further comprises:
a memory;
a signal processor; and
a set of program instructions stored in the memory and executable by the signal processor to decode a received data stream according to an algorithm that employs a method from the group comprising discrete cosine transform (DCT), fractal compression, matching pursuits, and discrete wavelet transform.

19. A computing server apparatus, comprising:
an extendable network of computing resources;
an encoder, the encoder configured to compressively encode a video stream using an algorithm, said video stream derived from a virtual graphical user interface (GUI) of a virtual machine running within the extendable network of computing resources;
a transmitting circuit coupled to the encoder, the transmitting circuit operable to communicate an encoded video stream to a remote client; and
a receiving circuit operable to receive information from the remote client, the information configured to control the virtual machine.

20. The computing server apparatus of claim 17, further comprising:
a processor configured to allocate additional computing resources according to the information received from the remote client and further configured to release computing resources according to the information received from the remote client.
